(19) United States
(12) Patent Application Publication
(10) Pub. No.: US 2014/0352519 A1
(43) Pub. Date: Dec. 4, 2014

(54) MODULAR WIND CHIME SYSTEM

(71) Applicant: Zuriel Lee Schmidt, Calgary (CA)

(72) Inventor: Zuriel Lee Schmidt, Calgary (CA)

(21) Appl. No.: 14/177,833

(22) Filed: Feb. 11, 2014

(30) Foreign Application Priority Data
May 30, 2013 (CA) 2,818,379

(51) Int. Cl. G10K 1/06

(52) U.S. Cl. CPC G10K 1/06
USPC 84/404; 84/403

(57) ABSTRACT

The invention provides a modular wind chime system having a plurality of modules which can be readily connected and disconnected, based on user preference. A supporting platform includes a plurality of receptacles which enable the coupling of various modules through the use of releasable fasteners.

The invention pertains generally to wind chimes. Wind chimes are chimes constructed from suspended tubes or other objects, and are often hung outdoors as visual and aural ornaments. Wind chimes often comprise a set of chimes and a supporting platform from which the chimes are suspended by means of string, cord, or wire. A striker is used to strike the chimes, to produce a musical tone. A sail is often attached to the striker, to produce movement when driven by the wind.

Commercial wind chimes are generally produced and assembled by manufacturers with a preselected set of chimes, producing a given set of musical tones. While this can provide convenience for the manufacturer, it also limits the user to the set of musical tones that the manufacturer has preselected. Furthermore, if the set of chimes is damaged in some way, replacing the chimes often requires restringing the entire set, necessitating specialized tools and equipment.

It is an objective of the present invention to address and solve the disadvantages and limitations of prior wind chimes. It is an objective of the present invention to provide a modular wind chime system which has a plurality of interchangeable chime modules which can be readily connected and disconnected, according to user preference.

It is a further objective of the present invention to provide a modular wind chime system which allows the interchangeable use of several, all, or none of its available chime modules, by providing for quick and effective connections between the chime modules and the supporting platform.

These and other objectives are accomplished by the present invention, a modular wind chime system.

The novel features which are considered as characteristic of the invention are set forth in particular in the appended claims. The invention itself, however, both as to its design, construction, and use, together with additional features and advantages thereof, are best understood upon review of the following detailed description with reference to the accompanying drawings.

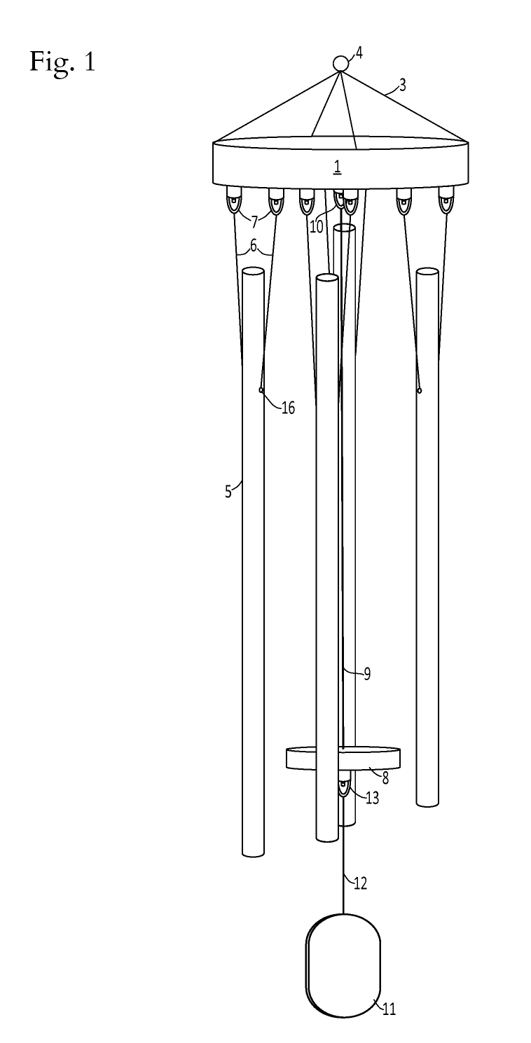

FIG. 1 is a front elevational view of the modular wind chime system

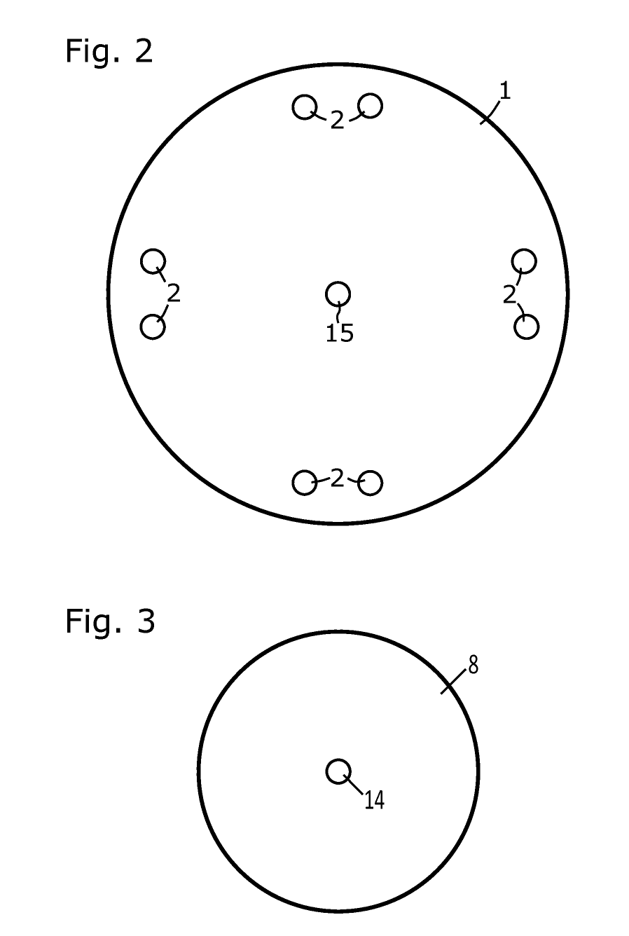

FIG. 2 is a bottom view of the supporting platform

FIG. 3 is a bottom view of the striker module

### DETAILED DESCRIPTION OF THE INVENTION

Supporting platform 1 provides a platform from which various modules can be suspended. It includes a plurality of receptacles 2, configured to removably retain the releasable fasteners 7 of the chime modules. In the current preferred embodiment of the invention, these receptacles 2 comprise sockets which are configured to removably retain a ball lock type fastener. However, it is to be understood that any type of receptacle can be used that will receive the releasable fasteners 7 of the chime modules. Supporting platform 1 also includes a receptacle 15 configured to removably retain the releasable fastener 10 of the striker module 8. In the current preferred embodiment of the invention, this receptacle 15 comprises a socket which is configured to removably retain a ball lock type fastener. However, it is to be understood that any type of receptacle can be used that will receive the releasable fastener 10 of the striker module 8. Supporting platform 1 further includes one or more suspension lines 3, attached to a ring or fastener 4, to provide for the modular wind chime system to be hung for use. In the current preferred embodiment of the invention, the supporting platform 1 comprises a disc-shaped structure. However, it is to be understood that the supporting platform 1 can be of any suitable shape or design, such as a ring-shaped structure. It is further contemplated that the supporting platform 1 will be fabricated from wood. However, it is to be understood that any type of suitable material can be used, such as plastic or metal.

Each chime module comprises a chime 5, one or more suspension lines 6, and one or more releasable fasteners 7 which enable the coupling of the chime module to receptacles 2 of the supporting platform 1. In the current preferred embodiment of the invention, the releasable fasteners 7 comprise ball lock type fasteners. However, this fastener is not to be considered restricted to that which is disclosed. Any suitable releasable fastener can be used. It is contemplated that each chime 5 will be supported by one or more suspension lines 6 being strung through apertures 16 created in the chime. However, it is to be understood that the chimes can also be supported by other means, such as an internal pin which is then attached to a suspension line. Furthermore, the apertures 16 of the chimes can include grommets for protecting the suspension lines 6 from damage. In the current preferred embodiment of the invention, the chimes 5 are formed from metal tubing, such as aluminum. However, it is to be understood that the chimes can be formed from various materials of various shapes and designs.

Striker module 8 is used to strike the chimes 5 to produce a musical tone, and can be of most any design and shape. Striker module 8 is suspended from the supporting platform 1 by means of a suspension line 9 having a releasable fastener 10 attached for releasable connection to a receptacle 15 of the supporting platform 1. In the current preferred embodiment of the invention, the releasable fastener 10 comprises a ball lock type fastener. However, this fastener is not to be considered restricted to that which is disclosed. Any suitable releasable fastener can be used. Striker module 8 includes a receptacle 14 configured to removably retain the releasable fastener 13 of the sail module 11. In the current preferred embodiment of the invention, this receptacle 14 comprises a socket which is configured to removably retain a ball lock type fastener. However, it is to be understood that any type of receptacle can be used that will receive the releasable fastener 13 of the sail module 11. It is contemplated that the striker module 8 will be fabricated from wood. However, it is to be understood that any type of suitable material can be used, such as plastic or metal.

Sail module 11 is used to produce movement of the striker module 8, and can be of most any design and shape. It is suspended from the striker module 8 by means of a suspension line 12 having a releasable fastener 13 attached for releasable connection to a receptacle 14 of the striker module 8.

In the current preferred embodiment of the invention, the releasable fastener 13 comprises a ball lock type fastener. However, this fastener is not to be considered restricted to that which is disclosed. Any suitable releasable fastener can be used. It is further contemplated that the sail module 11 will be fabricated from wood. However, it is to be understood that any type of suitable material can be used, such as plastic or metal.

1. A modular wind chime system, comprising:
a supporting platform; and
a plurality of chime modules configured to be used with the supporting platform, each chime module comprising:
a chime;
one or more suspension lines configured to suspend the chime; and
one or more releasable fasteners attached to the suspension line(s), wherein the releasable fasteners are configured to provide for releasable connection to the supporting platform.

2. The modular wind chime system of claim 1, wherein:
the supporting platform includes a plurality of receptacles configured to removably retain the releasable fasteners of the chime modules.

3. The modular wind chime system of claim 1, further comprising:
a striker module having at least one suspension line with a releasable fastener attached, configured to provide for releasable connection to the supporting platform; and
a sail module having at least one suspension line with a releasable fastener attached, configured to provide for releasable connection to the striker module.

4. The modular wind chime system of claim 3, wherein:
the supporting platform includes at least one receptacle configured to removably retain the releasable fastener of the striker module.

5. The modular wind chime system of claim 3, wherein:
the striker module includes at least one receptacle configured to removably retain the releasable fastener of the sail module.

6. The modular wind chime system of claim 2, wherein:
said receptacles comprise sockets.

7. The modular wind chime system of claim 4, wherein:
said receptacle comprises a socket.

8. The modular wind chime system of claim 5, wherein:
said receptacle comprises a socket.

9. The modular wind chime system of claim 6, wherein:
said sockets are configured to removably retain ball lock type fasteners.

10. The modular wind chime system of claim 7, wherein:
said socket is configured to removably retain a ball lock type fastener.

11. The modular wind chime system of claim 8, wherein:
said socket is configured to removably retain a ball lock type fastener.

12. The modular wind chime system of claim 1, wherein:
said releasable fasteners comprise ball lock type fasteners.

13. The modular wind chime system of claim 3, wherein:
said releasable fasteners comprise ball lock type fasteners.

14. The modular wind chime system of claim 1, wherein:
each chime is supported by one or more suspension lines being strung through apertures created in the chime.

15. The modular wind chime system of claim 14, wherein:
said apertures include grommets for protecting the suspension lines from damage.

16. The modular wind chime system of claim 1, wherein:
the chimes comprise metal tubing.

17. The modular wind chime system of claim 16, wherein:
said metal tubing comprises aluminum.

18. The modular wind chime system of claim 1, wherein:
the supporting platform includes one or more suspension lines to provide for the modular wind chime system to be hung for use.

19. The modular wind chime system of claim 1, wherein:
the supporting platform comprises a disc-shaped structure.

20. The modular wind chime system of claim 1, wherein:
the supporting platform comprises a ring-shaped structure.

21. The modular wind chime system of claim 3, wherein:
the striker module comprises a disc-shaped structure.

22. The modular wind chime system of claim 1, wherein:
the supporting platform comprises a rigid material.

23. The modular wind chime system of claim 3, wherein:
the striker module comprises a rigid material.

24. The modular wind chime system of claim 3, wherein:
the sail module comprises a rigid material.

25. The modular wind chime system of claim 22, wherein:
said rigid material comprises wood.

26. The modular wind chime system of claim 23, wherein:
said rigid material comprises wood.

27. The modular wind chime system of claim 24, wherein:
said rigid material comprises wood.

28. The modular wind chime system of claim 1, wherein:
the chimes are tuned to musical pitches.
